(19) United States
(12) Patent Application Publication
(10) Pub. No.: US 2023/0291718 A1
(43) Pub. Date: Sep. 14, 2023

(54) CENTRALIZED PLATFORM FOR PERFORMING PRE-TRANSMISSION DATA TRANSFORMATIONS

(71) Applicant: BANK OF AMERICA CORPORATION, Charlotte, NC (US)

(72) Inventors: Karen Lea MacQueen, Lyndhurst, OH (US); Jill Marie Moser, Louisville, KY (US); Kimberly C. Turner, Sicklerville, NJ (US)

(73) Assignee: BANK OF AMERICA CORPORATION, Charlotte, NC (US)

(21) Appl. No.: 17/690,638

(22) Filed: Mar. 9, 2022

(51) Int. Cl. H04L 9/40; H04L 67/1097

(52) U.S. Cl. CPC H04L 63/0421; H04L 63/102; H04L 63/20; H04L 67/1097

(57) ABSTRACT

Embodiments of the present invention provide a centralized for allowing communication and transmission of data between entities and third party entities to securely provide requisitions to users. The system is configured for receiving a requisition request from an entity system, wherein the requisition request is associated with a user, in response to receiving the requisition request, performing one or more data transformations to transform at least a part of data associated with the requisition request, transmitting transformed data associated with the requisition request to an intermediary system, transmitting one or more control signals to the intermediary system to cause the intermediary system to transmit the transformed data associated with the requisition request to one or more third party entities, and determining that the intermediary system received one or more requisitions from the one or more third party entities.

### BACKGROUND

Conventional systems do not have the capability to securely provide requisitions to users from third party entities. As such, there exists a need for a centralized platform that allows for communication and transmission of data between entities and third party entities to securely provide requisitions to users of the entity.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for allowing communication and transmission of data between entities and third party entities to securely provide requisitions to users. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention receives a requisition request from an entity system, wherein the requisition request is associated with a user, in response to receiving the requisition request, performs one or more data transformations to transform at least a part of data associated with the requisition request, transmits transformed data associated with the requisition request to an intermediary system, transmits one or more control signals to the intermediary system to cause the intermediary system to transmit the transformed data associated with the requisition request to one or more third party entities, and determines that the intermediary system received one or more requisitions from the one or more third party entities.

In some embodiments, the present invention extracts the one or more requisitions from the intermediary system and transmits the one or more requisitions to the entity system.

In some embodiments, the one or more data transformations comprise anonymizing user data associated with the user received with the requisition request from the entity system, generating an anonymized id to represent anonymized user data, and tagging the anonymized id with the anonymized user data.

In some embodiments, the present invention receives a notification from the intermediary system that an interaction associated with the anonymized id was detected.

In some embodiments, the present invention transmits the notification received from the intermediary system to the entity system.

In some embodiments, the requisition request is associated with a procurement of a resource.

In some embodiments, the one or more requisitions comprise at least an offer, a discount, and a rebate associated with the procurement of the resource.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for allowing communication and transmission of data between entities and third party entities to securely provide requisitions to users, in accordance with an embodiment of the invention;

FIG. 2 provides a block diagram illustrating the entity system 200 of FIG. 1, in accordance with an embodiment of the invention;

FIG. 3 provides a block diagram illustrating an centralized platform 300 of FIG. 1, in accordance with an embodiment of the invention;

FIG. 4 provides a block diagram illustrating the computing device system 400 of FIG. 1, in accordance with an embodiment of the invention; and

FIG. 5 provides a process flow for allowing communication and transmission of data between entities and third party entities to securely provide requisitions to users, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “resource entity” or “entity” may be any institution which involves in financial transactions. In some embodiments, the entity may be a financial institution which may include any financial institutions such as commercial banks, thrifts, federal and state savings banks, savings and loan associations, credit unions, investment companies, insurance companies and the like. As described herein, a “user” may be a customer or a potential customer of the entity. In some embodiments, a “user” may be a financial institution customer (e.g., an account holder or a person who has an account (e.g., banking account, credit account, or the like)). An “account” or “resource pool” may be the relationship that the customer has with the financial institution. Examples of accounts include a deposit account, such as a transactional account (e.g. a banking account), a savings account, an investment account, a money market account, a time deposit, a demand deposit, a pre-paid account, a credit account, a non-monetary customer information that includes only personal information associated with the customer, or the like. The account is associated with and/or maintained by a financial institution. As used herein, the term “third party entity” may be any organization that provides goods, products, services, or the like to the users associated with the entity.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access, develop, manage, maintain, test, and/or use one or more applications provided by the entity and/or the system of the present invention. In some embodiments, the user may be an employee of the entity. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

Proposition based interactions, i.e., loyalty marketing, based on strategic management allows entities to focus on growing and retaining customers by implementing requisitions, i.e., inducements. To provide this opportunity for users, entities often partner with third party platforms to integrate their proprietary digital platform with third party applications. This integration process to become more tedious and resource intensive for larger entities that simultaneously manage digital platforms for their many users and still wish to provide the requisition option for their users. Additionally, the integration process requires the entities to share proprietary data with third party entities and the implementation process requires the entities to share user data with third party entities, thereby increasing the exposure of the entity data and the user data. Therefore, there is a need for a system to alleviate the burden on larger entities and allow the entities to securely provide requisitions to users of the entity. The system of the present invention provides a centralized platform that establishes trusted indirect communication between the entities and third party entities to provide requisitions to users.

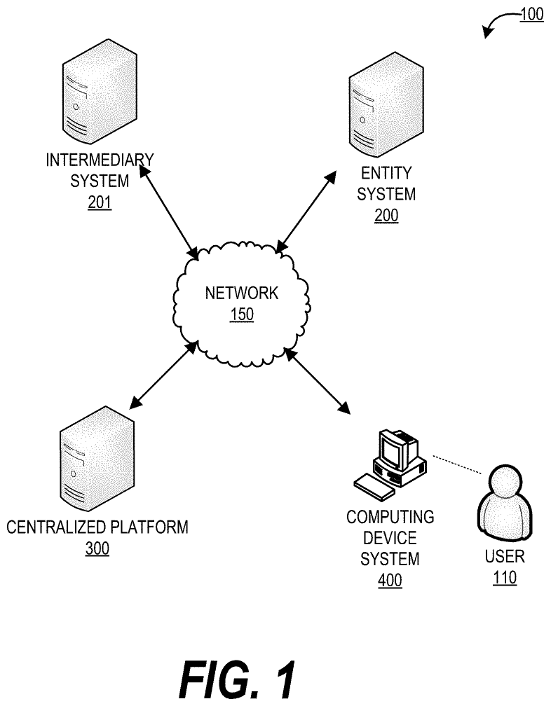

FIG. 1 provides a block diagram illustrating a system environment 100 for allowing communication and transmission of data between entities and third party entities to securely provide requisitions to users, in accordance with an embodiment of the invention. As illustrated in FIG. 1, the environment 100 includes a centralized platform 300, an entity system 200, an intermediary system 201, and computing device system 400. One or more users 110 may be included in the system environment 100, where the users 110 interact with the other entities of the system environment 100 via a user interface of the computing device system 400. In some embodiments, the one or more user(s) 110 of the system environment 100 may be customers or potential customers of an entity associated with the entity system 200.

The entity system(s) 200 may be any system owned or otherwise controlled by an entity to support or perform one or more process steps described herein. In some embodiments, the entity may be any organization that involves in financial transaction. In some embodiments, the entity is a financial institution. As used herein, “one or more third party systems” may be any systems associated with one or more third party entities that provides goods, products, services, or the like to the one or more users 110 associated with the entity. In some embodiments, the intermediary system 201 may be a system that has direct relation with one or more third parties as part of the business activities, where the intermediary system 201 onboards one or more third party entities, verifies the one or more third parties, and maintains any data associated with one or more third party entities. In such embodiments, the centralized platform 300 communicates with the intermediary system 201 and the entity system 200 to improve the processing efficiency of the entity system 200.

The centralized platform 300 is a system of the present invention for performing one or more process steps described herein. In some embodiments, the centralized platform 300 may be an independent system. In some embodiments, the centralized platform 300 may provide one or more software modules to the entity system 200 and the intermediary system 201, where the one or more software modules cause the entity system 200 and the intermediary system 201 to perform one or more actions.

The centralized platform 300, the entity system 200, the computing device system 400, and the intermediary system 201 may be in network communication across the system environment 100 through the network 150. In some embodiments, the entity system 200 and the intermediary system 201 may be in communication with the centralized platform and/or the computing device system 400 via the network 150, but may not be in network communication with each other. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the centralized platform 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the centralized platform 300, and/or entity system 200 across the network 150.

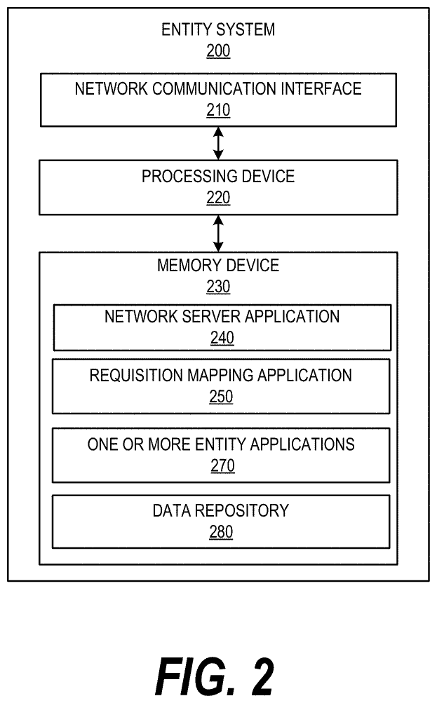

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a requisition mapping application 250, one or more entity applications 270, and a data repository 280 comprising historical transaction data associated with one or more resource pools of users 110. The requisition mapping application 250 may determine one or more products that the user may purchase in the future based on location data gathered from the computing device system (e.g., via an entity application 424) and/or the historical transaction data associated with one or more resource pools of the users 110. In some embodiments, the requisition mapping application 250 may communicate one or more requisition requests associated with the identified one or more products, where the requisition requests are request for one or more requisitions (e.g., offers, rewards, discounts, or the like) associated with the identified one or more products. The one or more entity applications 270 may be any applications developed, supported, maintained, utilized, and/or controlled by the entity that perform one or more organizational activities. In one embodiments, the entity application may be an online banking application. The computer-executable program code of the network server application 240, the requisition mapping application 250, the one or more entity application 270 to perform certain logic, data-extraction, and data-storing functions of the entity system 200 described herein, as well as communication functions of the entity system 200.

The network server application 240, the requisition mapping application 250, and the one or more entity applications 270 are configured to store data in the data repository 280 or to use the data stored in the data repository 280 when communicating through the network communication interface 210 with the centralized platform 300, and/or the computing device system 400 to perform one or more process steps described herein. In some embodiments, the entity system 200 may receive instructions from the centralized platform 300 via the requisition mapping application 250 to perform certain operations. In some embodiments, there may be a separate application provided by the centralized platform 300 that allows passing of instructions to the entity system 200.

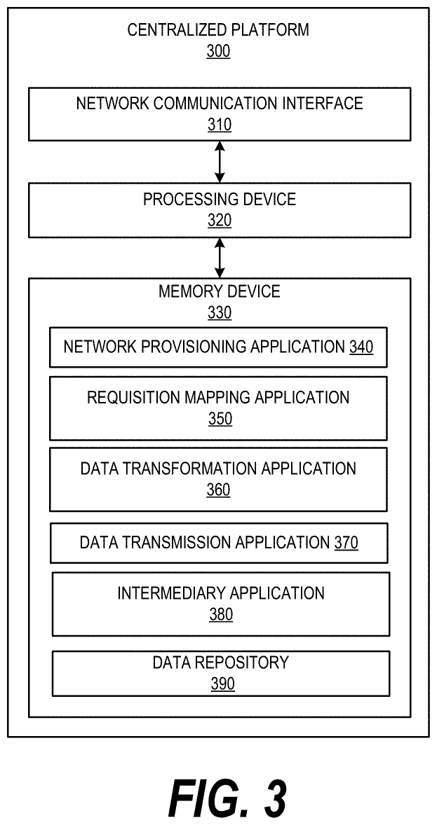

FIG. 3 provides a block diagram illustrating the centralized platform 300 in greater detail, in accordance with embodiments of the invention. As illustrated in FIG. 3, in one embodiment of the invention, the centralized platform 300 includes one or more processing devices 320 operatively coupled to a network communication interface 310 and a memory device 330. In certain embodiments, the centralized platform 300 is operated by an entity, such as a financial institution. In some embodiments, the centralized platform 300 is owned or operated by the entity of the entity system 200. In some embodiments, the centralized platform 300 may be an independent system. In alternate embodiments, the centralized platform 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the centralized platform 300 described herein. For example, in one embodiment of the centralized platform 300, the memory device 330 includes, but is not limited to, a network provisioning application 340, a requisition mapping application 350, a data transformation application 360, a data transmission application 370, an intermediary application 380, and a data repository 390 comprising any data processed or accessed by one or more applications in the memory device 330. The computer-executable program code of the network provisioning application 340, the requisition mapping application 350, the data transformation application 360, the data transmission application 370, and the intermediary application 380 may instruct the processing device 320 to perform certain logic, data-processing, and data-storing functions of the centralized platform 300 described herein, as well as communication functions of the centralized platform 300.

The network provisioning application 340, the requisition mapping application 350, the data transformation application 360, the data transmission application 370, and the intermediary application 380 are configured to invoke or use the data in the data repository 390 when communicating through the network communication interface 310 with the entity system 200, and/or the computing device system 400. In some embodiments, the network provisioning application 340, the requisition mapping application 350, the data transformation application 360, the data transmission application 370, and the intermediary application 380 may store the data extracted or received from the entity system 200, and the computing device system 400 in the data repository 390. In some embodiments, the network provisioning application 340, the requisition mapping application 350, the data transformation application 360, the data transmission application 370, and the intermediary application 380 may be a part of a single application.

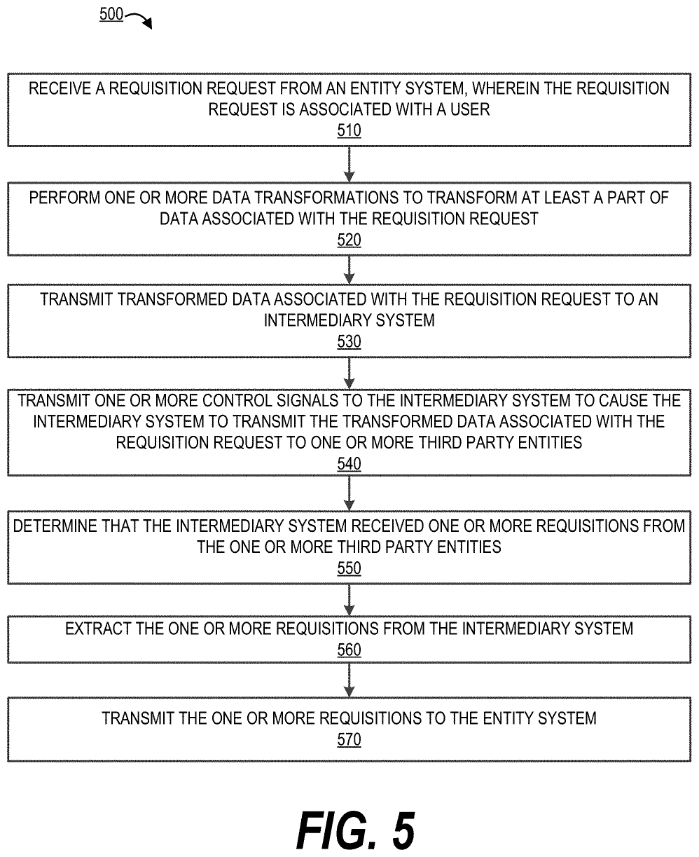

The requisition mapping application 350 may enable the centralized platform to communicate with the entity system, determine a match for one or more third party entities and the one or more products identified by the entity system 200 as explained above. The data transformation application may be responsible for performing one or more data transformation operations as explained in detail in FIG. 5. The data transmission application 370 may securely transmit the data from the centralized platform to the entity system 200 and the intermediary system 201. In some embodiments, the data transmission application 370 may add an encryption layer before transmitting the data. The intermediary application 380 may allow the centralized platform 300 to communicate with the intermediary system 201.

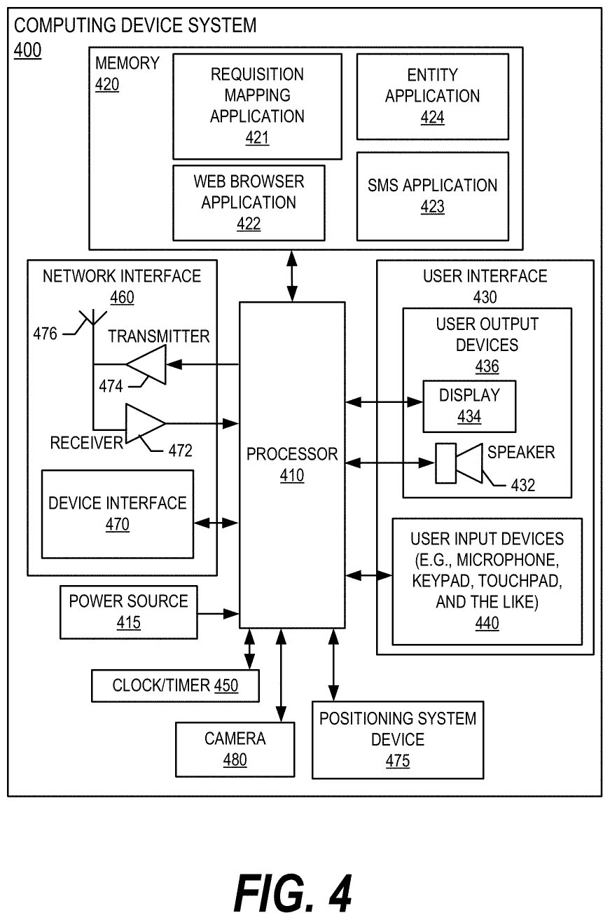

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a requisition mapping application 421, and an entity application 424. In some embodiments, the memory 420 may further comprise one or more third party application provided by the one or more third party entities. These applications also typically instructions to a graphical user interface (GUI) on the display 430 that allows the user 110 to interact with the entity system 200, the centralized platform 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the entity application 424 may be an online banking application. In some embodiments, the requisition mapping application 421 provided by the centralized platform 300 allows the user 110 to access the centralized platform 300. In some embodiments, the entity application 424 provided by the entity system 200 and the requisition mapping application 421 allow the user 110 to access the functionalities provided by the centralized platform 300 and the entity system 200. In some embodiments, there may not be direct communication between the computing device system 400 and the centralized platform 300.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

FIG. 5 provides a process flow for allowing communication and transmission of data between entities and third party entities to securely provide requisitions to users, in accordance with an embodiment of the invention. As shown in block 510, the system receives a requisition request from an entity system, wherein the requisition request is associated with a user. The requisition request may comprise a request for one or more requisitions associated with one or more products identified by the entity system for one or more users. For example, the entity system may determine that a first user is likely to purchase a first product based on transaction history, location data, or the like associated with the first user and may transmit a requisition request for one or more requisitions associated with the first product. In some embodiments, the requisition request may comprise user data comprising Personally Identifiable Information (PII), resource credentials (e.g., credit card information, account information, or the like), and/or the like associated with the one or more users associated with the entity.

As shown in block 520, the system performs one or more data transformations to transform at least a part of data associated with the requisition request. The one or more data transformations may comprise anonymizing user data associated with the user received with the requisition request from the entity system, generating an anonymized id to represent anonymized user data, and tagging the anonymized id with the anonymized user data. For example, anonymizing the data may comprise removing any PII, resource credentials, or the like associated with the users.

As shown in block 530, the system transmits transformed data associated with the requisition request to an intermediary system. The system may transmit the one or more products associated with the requisition request and the anonymized id to the intermediary system. In some embodiments, the intermediary system communicates with one or more third parties and verifies presence of third party accounts created by the one or more users utilizing one or more third party systems associated with the one or more third parties. In some embodiments, the system may map one or more third party entities to the one or more products associated with the one or more requisition requests and may transmit the data to the intermediary system.

As shown in block 540, the system transmits one or more control signals to the intermediary system to cause the intermediary system to transmit the transformed data associated with the requisition request to the one or more third party entities. The one or more control signals may instruct a software module present in the intermediary system to perform one or more actions, where the software module is provided by the system of the present invention.

As shown in block 550, the system determines that the intermediary system received one or more requisitions from the one or more third party entities. In response to causing the intermediary system to transmit the transformed data associated with the requisition request to the one or more third parties, the one or more third parties may communicate one or more requisitions associated with the one or more products back to the intermediary system. The system may monitor communications received from the one or more third parties, via the software module and may determine that the intermediary system has received one or more requisitions associated with the requisition request.

As shown in block 560, the system extracts the one or more requisitions from the intermediary system, via the software module. As shown in block 570, the system transmits the one or more requisitions to the entity system. the entity system may present the one or more requisitions to the one or more users via the entity application 424 present in the computing device system 400 associated with the one or more users. In some embodiments, the system directly or indirectly via the intermediary system monitors one or more interactions associated with the anonymized id associated with the user. In response to identifying the one or more interactions associated with the anonymized id, notifies the entity system 200 and the one or more third party entities about the one or more interactions associated with the one or more products and/or the one or more requisitions. In some embodiments, in response to receiving the notification, the entity system 200 may generate and settle one or more invoices associated with the one or more interactions directly with the one or more third parties associated with the one or more requisitions.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| U.S. patent | | |
|---|---|---|
| application | | |
| Ser. No. | Title | Filed On |
| 17/582,399 | SYSTEM FOR TRIGGERING ADAPTIVE | Jan. 24, 2022 |
| | RESOURCE CHANNEL REQUISITION | |
| | WITHIN A DISTRIBUTED NETWORK | |
| 17/684,167 | REVERSE LINKAGE OF AUXILIARY | Mar. 1, 2022 |
| | RESOURCES TO A RESOURCE | |
| | LOCATION AND RESOURCE- | |
| | RECEIVING ENTITY | |

1. A system for allowing communication and transmission of data between entities and third party entities to securely provide requisitions to users, the system comprising:
at least one network communication interface;
at least one non-transitory storage device; and
at least one processing device coupled to the at least one non-transitory storage device and the at least one network communication interface, wherein the at least one processing device is configured to:
receive a requisition request from an entity system, wherein the requisition request is associated with a user;
in response to receiving the requisition request, perform one or more data transformations to transform at least a part of data associated with the requisition request;
transmit transformed data associated with the requisition request to an intermediary system;
transmit one or more control signals to the intermediary system to cause the intermediary system to transmit the transformed data associated with the requisition request to one or more third party entities; and
determine that the intermediary system received one or more requisitions from the one or more third party entities.

2. The system of claim 1, wherein the at least one processing device is configured to:
extract the one or more requisitions from the intermediary system; and
transmit the one or more requisitions to the entity system.

3. The system of claim 1, wherein the one or more data transformations comprise:
anonymizing user data associated with the user received with the requisition request from the entity system;
generating an anonymized id to represent anonymized user data; and
tagging the anonymized id with the anonymized user data.

4. The system of claim 3, wherein the at least one processing device is configured to:
receive a notification from the intermediary system that an interaction associated with the anonymized id was detected.

5. The system of claim 4, wherein the at least one processing device is further configured to transmit the notification received from the intermediary system to the entity system.

6. The system of claim 1, wherein the requisition request is associated with a procurement of a resource.

7. The system of claim 6, wherein the one or more requisitions comprise at least an offer, a discount, and a rebate associated with the procurement of the resource.

8. A computer program product for allowing communication and transmission of data between entities and third party entities to securely provide requisitions to users, the computer program product comprising a non-transitory computer-readable storage medium having computer executable instructions for causing a computer processor to perform the steps of:
receiving a requisition request from an entity system, wherein the requisition request is associated with a user;
in response to receiving the requisition request, performing one or more data transformations to transform at least a part of data associated with the requisition request;
transmitting transformed data associated with the requisition request to an intermediary system;
transmitting one or more control signals to the intermediary system to cause the intermediary system to transmit the transformed data associated with the requisition request to one or more third party entities; and
determining that the intermediary system received one or more requisitions from the one or more third party entities.

9. The computer program product of claim 8, wherein the computer executable instructions cause the computer processor to perform the steps of:
extracting the one or more requisitions from the intermediary system; and
transmitting the one or more requisitions to the entity system.

10. The computer program product of claim 8, wherein the one or more data transformations comprise:
anonymizing user data associated with the user received with the requisition request from the entity system;
generating an anonymized id to represent anonymized user data; and
tagging the anonymized id with the anonymized user data.

11. The computer program product of claim 10, wherein the computer executable instructions cause the computer processor to perform the step of receiving a notification from the intermediary system that an interaction associated with the anonymized id was detected.

12. The computer program product of claim 11, wherein the computer executable instructions cause the computer processor to perform the step of transmitting the notification received from the intermediary system to the entity system.

13. The computer program product of claim 8, wherein the requisition request is associated with a procurement of a resource.

14. The computer program product of claim 13, wherein the one or more requisitions comprise at least an offer, a discount, and a rebate associated with the procurement of the resource.

15. A computer implemented method for allowing communication and transmission of data between entities and third party entities to securely provide requisitions to users, wherein the method comprises:
receiving a requisition request from an entity system, wherein the requisition request is associated with a user;
in response to receiving the requisition request, performing one or more data transformations to transform at least a part of data associated with the requisition request;
transmitting transformed data associated with the requisition request to an intermediary system;
transmitting one or more control signals to the intermediary system to cause the intermediary system to transmit the transformed data associated with the requisition request to one or more third party entities; and
determining that the intermediary system received one or more requisitions from the one or more third party entities.

16. The computer implemented method of claim 15, wherein the method comprises:
extracting the one or more requisitions from the intermediary system; and
transmitting the one or more requisitions to the entity system.

17. The computer implemented method of claim 15, wherein the one or more data transformations comprise:
anonymizing user data associated with the user received with the requisition request from the entity system;
generating an anonymized id to represent anonymized user data; and
tagging the anonymized id with the anonymized user data.

18. The computer implemented method of claim 17, wherein the method further comprises receiving a notification from the intermediary system that an interaction associated with the anonymized id was detected.

19. The computer implemented method of claim 18, wherein the method further comprises transmitting the notification received from the intermediary system to the entity system.

20. The computer implemented method of claim 15, wherein the requisition request is associated with a procurement of a resource.
